(19) United States
(12) Patent Application Publication
(10) Pub. No.: US 2022/0280983 A1
(43) Pub. Date: Sep. 8, 2022

(54) HIGH PRESSURE CLEANING SYSTEM AND METHOD FOR OPERATING A HIGH PRESSURE CLEANING SYSTEM

(71) Applicant: Alfred Kärcher SE & Co. KG, Winnenden (DE)

(72) Inventors: Andreas Friederich, Backnang (DE); Michael Albiez, Stuttgart (DE); Tobias Masek, Aidlingen (DE); Timo Spengler, Weil der Stadt (DE); Angelika Mohr, Stuttgart (DE)

(21) Appl. No.: 17/587,902

(22) Filed: Jan. 28, 2022

Related U.S. Application Data
(63) Continuation of application No. PCT/EP2019/070673, filed on Jul. 31, 2019.

(51) Int. Cl. B08B 3/02; B05B 1/04; B05B 9/01

(52) U.S. Cl. CPC B08B 3/028; B05B 1/04; B05B 9/01; B08B 2203/0217; B08B 2203/027

(57) ABSTRACT

The invention relates to a high pressure cleaning system including a high pressure cleaning appliance operable with at least one variable operating parameter that has a pump assembly, at least one accessory that is in or is bringable into flow connection with a high pressure outlet of the pump assembly, an input unit, at least one control unit coupled to the input unit, and an output unit coupled to the at least one control unit, wherein an object to be cleaned is specifiable by the input unit and a cleaning recommendation is providable on the output unit by the at least one control unit in dependence on the specification, and wherein at least one interaction element is provided for the user, linked to the cleaning recommendation, on the output unit for transmitting interaction information to the at least one control unit, in particular in dependence on the cleaning recommendation.

### CROSS-REFERENCE TO RELATED APPLICATION

This application is a continuation patent application of international application number PCT/EP2019/070673, filed on Jul. 31, 2019, which is incorporated herein by reference in its entirety and for all purposes.

### FIELD OF THE INVENTION

The present invention relates to a high pressure cleaning system, comprising a high pressure cleaning appliance that has a pump assembly, at least one accessory that is in or is bringable into flow connection with a high pressure outlet of the pump assembly, wherein the high pressure cleaning appliance is operable with at least one variable operating parameter, and further comprising an input unit, at least one control unit coupled to the input unit, and an output unit coupled to the at least one control unit, wherein an object to be cleaned is specifiable by way of the input unit and a cleaning recommendation is providable on the output unit by the at least one control unit in dependence on the specification.

Furthermore, the present invention relates to a method for operating a high pressure cleaning system of that kind.

### BACKGROUND OF THE INVENTION

A high pressure cleaning system of the kind stated at the outset is described in WO 2016/066209 A1. Here, the user is able to select the kind of object to be cleaned by means of a pictogram on the input unit. In dependence thereon, an operating parameter of the high pressure cleaning appliance is set, for example the pressure or the volumetric flow of the cleaning liquid. A discharge unit recommended for the cleaning of the object is symbolically depicted on the output unit.

In a different embodiment of a high pressure cleaning system that is also described in WO 2016/066209 A1, the user is able to specify the value of an operating parameter by way of the input unit. The specification by the user is set on the high pressure cleaning appliance in order to vary the properties of the cleaning liquid and to influence the cleaning result.

A high pressure cleaning system is described in US 2013/0214059 A1. Here, the user, as described in WO 2016/066209 A1, is able to specify the kind of object to be cleaned on the input unit by means of a pictogram. At least one operating parameter of the high pressure cleaning appliance is set in dependence thereon. However, no recommendation of a discharge unit is outputted on the output unit. Furthermore, described in US 2013/0214059 A1 is an embodiment of a high pressure cleaning system in which the user selects on an operating unit a discharge unit that comprises a nozzle suited for the cleaning task. By means of a drive, the selected discharge unit can be brought into flow connection with the high pressure outlet.

Further, guides for the use of a high pressure cleaning system are known, in which different kinds of objects to be cleaned are symbolically depicted in printed form. Linked to these depictions are instructions for the use of the high pressure cleaning appliance. The instructions comprise the depiction of a discharge unit suited for the cleaning of the object as well as the recommendation as to which pressure level is to be used.

It is an object of the present invention to provide a high pressure cleaning system and a method for operating a high pressure cleaning system that has a greater versatility.

### SUMMARY OF THE INVENTION

In a first aspect of the invention, a high pressure cleaning system comprises a high pressure cleaning appliance that has a pump assembly, at least on accessory that is in or is bringable into flow connection with a high pressure outlet of the pump assembly. The high pressure cleaning appliance is operable with at least one variable operating parameter and comprises an input unit, at least one control unit coupled to the input unit, and an output unit coupled to the at least one control unit. An object to be cleaned is specifiable by way of the input unit and a cleaning recommendation is providable on the output unit by the at least one control unit in dependence on the specification, said cleaning recommendation comprising an instruction for using an accessory and/or the value of at least one operating parameter. At least one interaction element for the user is providable, linked to the cleaning recommendation, on the output unit for transmitting interaction information to the at least one control unit, in particular in dependence on the cleaning recommendation.

In a second aspect of the invention, a method for operating a high pressure cleaning system is provided. The high pressure cleaning system comprises a high pressure cleaning appliance that has a pump assembly, at least one accessory that is in or is bringable into flow connection with a high pressure outlet of the pump assembly. The high pressure cleaning appliance is operable with at least one variable operating parameter. A user specifies an object to be cleaned to a control unit by way of an input unit and the control unit provides a cleaning recommendation on an output unit in dependence on the specification, said cleaning recommendation comprising an instruction for using an accessory and/or the value of at least one operating parameter. At least one interaction element, linked to the cleaning recommendation, for the user is providable on the output unit for transmitting interaction information to the at least one control unit, in particular in dependence on the cleaning recommendation.

### BRIEF DESCRIPTION OF THE DRAWINGS

The foregoing summary and the following description may be better understood in conjunction with the drawing figures, of which:

FIG. 1 shows a schematic depiction of a high pressure cleaning system in accordance with the invention, comprising a high pressure cleaning appliance, an external accessory device, and a plurality of accessories;

FIG. 2 shows a depiction of a further accessory of the high pressure cleaning system from FIG. 1;

FIG. 3 shows a schematic depiction of the accessory from FIG. 1;

FIGS. 4 to 6 show different accessory devices that may be used in the high pressure cleaning system alternatively or in addition to the accessory device depicted in FIG. 1;

FIG. 7 shows a schematic depiction of an input unit of the accessory device;

FIG. 8 shows a schematic depiction of an output unit of the accessory device on which the cleaning recommendations are displayed;

FIG. 9 shows a depiction corresponding to FIG. 8 with different cleaning recommendations;

FIG. 10 shows a further preferred embodiment, similar to FIG. 1, of the high pressure cleaning system in accordance with the invention;

FIG. 11 shows a further schematic depiction of the high pressure cleaning system from FIG. 1;

FIG. 12 shows schematically the depiction of an accessory device and a high pressure cleaning appliance in a further preferred embodiment of the high pressure cleaning system in accordance with the invention;

FIGS. 13 to 15 show schematically the depiction of an output unit of the accessory device for selecting the object to be cleaned, the cleaning recommendation, and during the operation of the high pressure cleaning system; and

FIGS. 16 to 28 show schematically the depiction of an output unit of the accessory device with the selection of the object to be cleaned, the cleaning recommendation, and including the output of cleaning instructions in a step-by-step guide for the user.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a high pressure cleaning system comprising a high pressure cleaning appliance that has a pump assembly, at least on accessory that is in or is bringable into flow connection with a high pressure outlet of the pump assembly, wherein the high pressure cleaning appliance is operable with at least one variable operating parameter, an input unit, at least one control unit coupled to the input unit, and an output unit coupled to the at least one control unit, wherein an object to be cleaned is specifiable by way of the input unit and a cleaning recommendation is providable on the output unit by the at least one control unit in dependence on the specification, said cleaning recommendation comprising an instruction for using an accessory and/or the value of at least one operating parameter, and wherein at least one interaction element for the user is providable, linked to the cleaning recommendation, on the output unit for transmitting interaction information to the at least one control unit, in particular in dependence on the cleaning recommendation.

The versatility of the high pressure cleaning system in accordance with the invention results from the fact that it is possible for the user to, by way of the at least one interaction element, transmit interaction information to the at least one control unit in response to the cleaning recommendation that is outputted. The quality of the at least one interaction element and the interaction information transmittable to the at least one control unit may, in particular, be dependent on the cleaning recommendation. In a preferred embodiment, a dialogue between the user and at least one control unit can preferably thereby be established by the user being able to react to the dynamic cleaning recommendation and advantageously being able to adapt and, in particular, refine said cleaning recommendation for his/her needs, if necessary. This makes it possible to express a best possible cleaning recommendation with a view to the cleaning task, in particular by means of a dialogue-like or workflow-like exchange of information between the user and the high pressure cleaning system, wherein the user can preferably simultaneously be instructed to perform the cleaning. Alternatively or in addition, provision is favorably made that upon actuation of the interaction element, cleaning instructions are provided, for example in a workflow-like or dialogue-like manner, by the at least one control unit on the output unit, which cleaning instructions instruct the user in the use of the high pressure cleaning system with a view to a best possible cleaning.

The output unit advantageously is or comprises a display unit, wherein an image display is preferably provided and the cleaning recommendation as well as the at least one interaction element can be visually represented.

The cleaning recommendation for the accessory and/or the value of the at least one operating parameter may be providable, e.g., in graphical form, text form, and/or by voice output and may comprise, in particular, graphical elements and/or text and/or audio elements.

For example, the at least one interaction element is providable and, in particular, displayable on the output unit in the form of a button, a selection element, or a rotary and/or slide control. By actuating the button, selecting an action provided on the selection element, or setting the control with which, for example, the value of at least one operating parameter can be varied, the user is able to interact with the high pressure cleaning system.

In a preferred embodiment, provision may be made that the output unit is of acoustic configuration. “Interaction element” is thus not limited to a visually represented and, for example, haptically actuatable element. The cleaning recommendation can be provided on the acoustic output unit, for example by speech output.

In a corresponding manner, provision may be made that the at least one interaction element is providable by a voice output with the possibility of responding to the voice output. An interaction, for example, by means of voice input by the user can thus be made possible.

Provision may be made that the at least one interaction element is providable on the input unit by optically linking a display element to a physical actuation element. For example, a physical actuation element in the form of a button or the like may be provided on the input unit. This actuation element may be visually linked as a “softkey” to a display element that is displayable on the output unit. For example, the user is notified that a certain interaction is enabled by actuating the actuation element.

It is advantageous if the cleaning recommendation comprises an instruction for use of an accessory together with the value of at least one operating parameter. The user thus obtains a comprehensive, useful recommendation to achieve a best possible cleaning result.

In particular, provision may be made that the cleaning recommendation may comprise an indication relating to the values of a plurality of operating parameters, also for achieving a best possible cleaning result.

Provision may be made, in particular, that more than one interaction element is providable. The interaction elements may be constituted in different ways with respect to their effect, such that different interaction information is transmittable to the control unit depending on the actuation. In the context of the present disclosure, the phrase “the at least one interaction element” can thus be interpreted to mean “at least one interaction element of the at least one interaction element”.

Provision may be made that the high pressure cleaning system comprises more than one control unit. Thus, in the context of the present disclosure, the phrase “the at least one control unit” can be interpreted to mean “at least one control unit of the at least one control unit”.

The at least one interaction element preferably comprises a confirmation element, by the actuation of which a confirmation information of the user is transmittable to the at least one control unit. By actuating the confirmation element, the user can thus communicate to the control unit that he/she has taken notice of the cleaning recommendation and, in particular, acknowledge same. In a way, the user accepts, by means of the interaction element, the cleaning recommendation by the control unit.

It is favorable if the cleaning recommendation comprises an indication relating to the value of at least one operating parameter and if the high pressure cleaning appliance is settable to the value of the at least one operating parameter upon confirmation by the at least one interaction element. The user can react to the cleaning recommendation and accept the suggested value of the at least one operating parameter. The high pressure cleaning appliance is set to this value in a user-friendly manner.

It is understood that information can be exchanged between the input unit and the high pressure cleaning appliance as necessary. For example, interaction information that is made on the input unit is transmitted to a control unit and can be transmitted by the latter directly or indirectly to the high pressure cleaning appliance. Alternatively, the information may be transmitted by the input unit, e.g., to a control unit arranged in the high pressure cleaning appliance.

It is advantageous if the cleaning recommendation comprises an indication relating to the value of at least one operating parameter and if the at least one interaction element is a changing element, by way of which the value of the at least one operating parameter can be changed by the user. By way of the changing element, for example configured as a rotary or slide control or as a selection element, the user can provide feedback to the high pressure cleaning system that he/she considers a different value for the at least one operating parameter to be advantageous.

It is favorable if, in the case of the last mentioned embodiment, information relating to this is transmitted to the at least one control unit and the high pressure cleaning appliance is settable to the changed value of the at least one operating parameter. This increases the user friendliness of the high pressure cleaning system. As explained above, information can be transmitted to the high pressure cleaning appliance as necessary.

It is advantageous if the cleaning recommendation comprises an indication relating to the value of at least one operating parameter and if the high pressure cleaning appliance, in the absence of an actuation of the at least one interaction element for a predetermined or predeterminable time after provision of the cleaning recommendation, is set to the value of the at least one operating parameter. It is made possible for the user to give feedback to the high pressure cleaning system by way of the at least one interaction element. In the present case, it is favorable, however, if after a certain period of time without feedback, the value of the at least one operating parameter is set, automatically to an extent, without further action by the user.

It may prove to be advantageous if a plurality of cleaning recommendations connected to a respective at least one interaction element are providable and if the cleaning recommendations comprise at least one indication relating to the use of an accessory, wherein the accessories of different cleaning recommendations differ from one another. In practice, provision may well be made that mutually different accessories can be used to clean a particular object. Thus, the at least one control unit may provide more than one cleaning recommendation.

In the latter case, it is advantageous if the respective at least one interaction element forms a confirmation element or a selection element, upon actuation of which information for using the accessory linked to said interaction element is transmittable to the control unit. This makes it possible for the user to communicate to the control unit that he/she selects one of the accessories for the cleaning. The value of at least one operating parameter is thereby favorably provided by way of the interaction. Here, provision may be made that the user confirms the suggested value of the operating parameter or transmits a value on his/her own. In practice, it may be in fact be such that values of operating parameters for different accessories that are each suited for cleaning the object may differ from one another.

Overall, it is advantageous if the value of at least one operating parameter is variable by means of the at least one interaction element.

It is favorable if the high pressure cleaning appliance is settable to the value of the at least one operating parameter without prior confirmation or change by the user. This makes it possible to set the high pressure cleaning appliance to the value in accordance with the cleaning recommendation without intervention by the user and thus effectively automatically, thereby increasing the user friendliness of the high pressure cleaning system. Provision may be made that the setting of the high pressure cleaning appliance takes place directly and without waiting for a duration of time to pass, as was previously described.

The at least one interaction element may comprise a request element, upon actuation of which a request is transmittable to the control unit to provide a different cleaning recommendation. For example, an accessory is suggested to the user that he/she, by virtue of his/her own experience, find to be less suitable. The user can request a different cleaning recommendation by means of the interaction element. Alternatively, provision may be made that the user is not in possession of the suggested accessory and requests the proposal of a new cleaning recommendation with an alternative recommendation for the accessory.

Provision may be made that the cleaning recommendation comprises an indication relating to the use of an accessory and that the at least one interaction element comprises an acquisition element, upon actuation of which an acquisition request of the user relating to the accessory is transmittable to a spatially remote data processing device. For example, the user in the last-mentioned case in which he/she is not in possession of the suggested accessory can transmit an acquisition request to acquire the suggested accessory. The at least one control unit can transmit the acquisition request to a data processing device. There, the acquisition request can, for example, be automatically processed in order to initiate a shipment of the accessory to the user.

The at least one operating parameter can advantageously be set manually by the user on the high pressure cleaning appliance or on an operating unit thereof.

Provision may be made that the value of at least one operating parameter is controllable and/or regulatable during the operation of the high pressure cleaning appliance.

The at least one interaction element is favorably providable together with the cleaning recommendation on the output unit. This makes it easier for the user to handle the high pressure cleaning system.

Provision may be made that the at least one interaction element is providable on the output unit only after instruction by the user by way of the input unit or after expiration of a predeterminable or predetermined time. For example, the cleaning recommendation is provided to the user on the output unit and the interaction element is provided only after triggering a respective request of the user by way of the input unit. Alternatively or in addition, provision may be made that the at least one interaction element is provided only after a certain period of time.

In a preferred embodiment, the cleaning recommendation may comprise a plurality of accessories. In practice, it may be advantageous if the object to be cleaned is cleaned with different accessories that are used one after the other. For example, for cleaning a motor vehicle, first a flat jet nozzle may be used for pre-cleaning, then a foam nozzle together with a cleaning chemical for applying foam to the vehicle, then a washing brush for fine cleaning the vehicle, and finally a flat jet nozzle for removing the cleaning residues. In the cleaning of a bicycle, for example, first a flat jet nozzle may be used for pre-cleaning and then a cleaning brush for fine cleaning.

A plurality of accessories as a constituent part of the cleaning recommendation may therefore be provided, in particular, for use in chronological succession, preferably according to cleaning instructions that are providable on the output unit by the at least one control unit. As explained in the following, the user can be instructed with cleaning instructions for using and exchanging the accessories, for example by means of a guide provided by way of the output unit.

In a preferred embodiment of the invention, the at least one interaction element may comprise, e.g., a request element, upon actuation of which by the user at least one cleaning instruction for cleaning the object is providable on the output unit by the at least one control unit. The provision of the cleaning instruction facilitates the user's handling of the high pressure cleaning system. A guide assisting the user in cleaning is preferably provided.

The guide or the at least one cleaning instruction is providable, for example, in graphical form, in text form, and or by voice output, and may comprise, in particular, graphical elements and/or text and/or audio elements.

The guide or the at least one cleaning instruction may preferably be a constituent part of the cleaning recommendation.

The at least one cleaning instruction may be displayed, in particular, on a display unit as which the output unit is configured.

It may be advantageous if successive cleaning instructions are providable on the output unit the form of a step-by-step guide for the user for cleaning the object. The high pressure cleaning system proves to be particularly user-friendly as a result. The user can be instructed in a clear manner so as to achieve a best possible cleaning result. All necessary cleaning steps can hereby be explained by way of the cleaning instructions.

It may be favorable if the guide is providable with respective interaction elements for the user, wherein the cleaning instruction according to the subsequent step of the guide is providable upon actuation of an interaction element. By way of such a workflow of the guide, the user is successively informed, after respective actuation of an interaction element, of the subsequent step for cleaning the object.

In a preferred embodiment of the invention, cleaning instructions that are providable on the output unit may be or comprise at least one of the following:
instruction for setting the high pressure cleaning appliance, in particular using the input unit. Here, for example, the value of at least one operating parameter can be set.
instruction for transmitting a value of an operating parameter to the high pressure cleaning appliance, for example the previously set operating parameter;
instruction for guiding an accessory for cleaning the object. Here, for example, movement patterns for the accessory and/or the working distance of the accessory can be suggested;
instruction for connecting an accessory to an operating unit or the high pressure cleaning appliance, for disconnecting an accessory, and/or for exchanging an accessory. For example, in the suggested use of different accessories one after the other, the user can be informed by way of the cleaning instructions that a change of the accessory is necessary or at least recommended;
instruction relating to the expired or remaining cleaning time, in particular the usage time of at least one accessory. For example, the cleaning instruction may comprise information as to how long the object is to be (at least) cleaned with the accessory. The cleaning instruction may comprise information relating to this or, advantageously, comprise a timer for this purpose.

It is advantageous if the high pressure cleaning system has a storage unit in which cleaning profiles are saved, which have cleaning recommendations, associated with objects to be cleaned, that have a linking of accessories to a value of at least one operating parameter. A respective cleaning profile may comprise a set of one or more cleaning recommendations with a respective accessory and the value of at least one operating parameter. The cleaning recommendations can be read on the storage unit and provided on the output unit.

It is favorable if cleaning profiles are variable and/or addable to the storage unit by the user by interacting with the high pressure cleaning appliance by way of the input unit and the output unit. For example, cleaning profiles for different objects can be supplemented with information that is stored in a data processing device. It is thus conceivable that cleaning profiles can be downloaded by the user by interacting with the system and be saved in the storage unit. Alternatively or in addition, provision may be made that the user can vary cleaning recommendations.

The storage unit is, in particular, coupled to the at least one control unit. It is conceivable that the storage unit is comprised by the control unit.

In the preferred embodiment of the high pressure cleaning system, at least one of the following may be provided as an accessory:
a discharge unit with a flat jet nozzle;
a discharge unit with a rotor nozzle;
a discharge unit with a low pressure cleaning agent nozzle, in particular for outputting a mixture of the cleaning liquid with a cleaning chemical;
a discharge device comprising two or more discharge units, wherein the cleaning recommendation comprises the use of a particular one of the discharge units;
a surface cleaning device;
a washing brush, for example with stationary or movable cleaning bristles;
a container for a cleaning chemical, wherein the cleaning recommendation recommends the use of such a cleaning chemical.

Provision may be made that the high pressure cleaning system comprises more than one input unit, more than one output unit, and/or more than one control unit. It is understood that more than one storage unit may be provided.

Provision may hereby be made that the information is processed by different control units. For example, a control unit can provide the cleaning recommendation and/or the cleaning instructions on the output unit. Interaction information triggered by the user by actuating the at least one interaction element can be transmitted to a different control unit (of the at least one control unit).

Provision may be made that information is transmittable between at least two of the following components of the high pressure cleaning system in a wireless and/or wired manner: high pressure cleaning appliance, input unit, output unit, at least one control unit, operating unit for the high pressure cleaning appliance, storage unit coupled to or comprised by the control unit, external data processing device.

It proves to be favorable if the input unit, the output unit, and/or the control unit form an integrated unit with a common housing or common support or are comprised by such an integrated unit. This makes it easier to handle the high pressure cleaning system.

In a preferred embodiment, the input unit, the output unit, the control unit, or the integrated unit is or is comprised by an external accessory device to the high pressure cleaning appliance.

In a preferred embodiment, the accessory device may be portable. It can thus be carried by the user during cleaning.

It is advantageous if an executable user application program is stored on the external accessory device for the interaction by the user with the high pressure cleaning system. The user application program is, e.g., an intuitively useable app in order to make it easier for the user to interact with the high pressure cleaning system. For example, the workflow described above with the step-by-step guide for cleaning the object is provided by the app.

The accessory device is, e.g., a smartphone, a tablet computer, a smartwatch, or a head-mounted device, in particular data glasses. The latter is understood to be an apparatus worn on the nose and ears. Spectacle lenses, in particular cut lenses, are not necessary, but may be provided.

Provision may be made that the high pressure cleaning system comprises a data processing device with a control unit, wherein the data processing device provides an internet portal for the user for interacting with the high pressure cleaning system, which can be accessed by way of the input unit, wherein outputs are providable by way of the output unit. In particular, alternatively or in addition to the user interacting by way of the user application program, the internet portal may be provided.

In a preferred embodiment, provision may be made that the input unit, the output unit, and/or at least one control unit are arranged on or comprised by the high pressure cleaning appliance. In particular, provision may be made that the use of an external accessory device is not necessary to utilize the advantages of the invention.

In a preferred embodiment, provision may be made that the input unit and/or the output unit is arranged on or comprised by an operating unit for the high pressure cleaning appliance, which is flow-connected to the high pressure cleaning appliance. The operating unit is advantageously a high pressure gun for the high pressure cleaning appliance.

In an advantageous embodiment, provision may be made that the accessory comprises an output unit. For example, the output unit on the accessory is of optical configuration, and a cleaning recommendation is provided to the user by an optical indication on the accessory, for example by way of a luminous element. The optical indication shows the user that the at least one control unit recommends the particular accessory.

As already mentioned, provision may be made that at least one control unit is arranged in or is comprised by the high pressure cleaning appliance.

At least one control unit may, as mentioned, be a constituent part of the integrated unit, in particular of the accessory device.

It may prove to be advantageous if at least one data processing device arranged spatially remote from the high pressure cleaning appliance is provided, which comprises at least one control unit. The data processing device is, for example, in the possession and/or under the administration of a manufacturer of the high pressure cleaning system.

In a preferred embodiment, the at least one data processing device is provided by way of a computer network and/or a cloud service. In particular, a plurality of data processing devices that are spatially remote from one another and are connected to one another by way of a communication network may be provided.

It is understood that the storage unit discussed above may be arranged spatially remote from the high pressure cleaning appliance and/or may be provided by way of at least one computer network and/or a cloud service.

As already mentioned, a wireless and/or wired communication between components of the high pressure cleaning system is possible. The communication may take place by way of at least one of the following: WiFi, Bluetooth, ZigBee, mobile data connection, for example by way of a SIM card and a mobile network.

In a preferred embodiment, a point-to-point communication, for example by means of Bluetooth, can take place between the portable accessory device and the high pressure cleaning appliance.

The at least one operating parameter may advantageously be or comprise one of the following:
pressure of the cleaning liquid;
pressure level of the pump assembly;
volumetric flow of the cleaning liquid;
volume level for cleaning liquid, wherein, for example, the amount of cleaning liquid conveyed by the pump assembly per unit of time can be set in steps;
admixing ratio of a cleaning chemical to the cleaning liquid;
working distance of the accessory from the object to be cleaned;
use of at least one particular nozzle of the accessory for discharge the cleaning liquid;
use of an operating mode with temporarily increased pressure (Boost) for the cleaning liquid.

Provision may be made that an operating mode with temporarily increased pressure (Boost Mode) is provided. The user can advantageously activate or deactivate the Boost Mode by way of the input unit. Provision may be made that the user can set the value of at least one operating parameter that is adopted during the Boost Mode.

For example, a Boost Mode may be restricted or even impossible in dependence on the object to be cleaned and/or on the accessory used.

It is conceivable that the Boost Mode can be activated or deactivated by way of the input unit, specifically the external accessory device.

Provision is favorably made that at least one operating parameter can be specified to the high pressure cleaning appliance by the user by way of the input unit and/or by way of an operating unit of the high pressure cleaning appliance, for example in the form of a high pressure gun.

Provision may be made that a value for at least one operating parameter is specifiable to the high pressure cleaning appliance in steps or steplessly. Alternatively or in addition, provision may be made that the value can be set by the high pressure cleaning appliance in steps or steplessly.

The input unit may be, e.g., of optical, touch-sensitive, and/or acoustic configuration. In a preferred embodiment, an optical input unit may comprise or be in operative connection with at least one camera and, in particular, digital camera.

The input unit is advantageously of touch-sensitive configuration with a touch-sensitive input element, wherein the object is specifiable by the user, in particular by actuating a button, a pictogram, an image, by inputting into an input field, and/or by selecting from a list. The touch-sensitive input unit is or comprises, for example, a touchscreen and is preferably used when using an app. The key may be provided, for example, by means of a virtual button. Alternatively or in addition, a pictogram with a symbolic representation of the object or an image of the object itself may be provided. Typing in the input field and/or selecting from a list of predefined objects is also conceivable.

Provision may be made that the input unit is of acoustic configuration with a microphone, wherein the object is specifiable by the user by means of voice input and/or the triggering of the at least one interaction element is performable by means of voice input. For example, the user can interact with the high pressure cleaning system in a voice-controlled manner. The feedback from the at least one control unit may take place, e.g., acoustically by way of a speaker of the output unit and/or optically on the output unit.

An integrated input/output unit that comprises a touchscreen may preferably be provided.

It is advantageous if the high pressure cleaning system comprises or forms a detection unit for detecting the object and if information from the detection unit relating thereto is transmittable to the at least one control unit and the at least one control unit is configured to determine the object and/or a quality thereof on the basis of the information. The high pressure cleaning system proves to be particularly user friendly and versatile as a result.

It may be favorable if the accessory device comprises or forms the detection unit. A separate detection unit can thereby be saved.

It may prove to be advantageous if the detection unit comprises a camera for creating at least one image of the object and image information relating thereto is transmittable to the at least one control unit, and if the control unit is configured to determine the object on the basis of the image information. For example, an external accessory device in the form of a smartphone, tablet computer, or a head-mounted device is used. The image may, for example, be created spontaneously or only upon triggering by the user. Image processing algorithms may be stored in the at least one control unit, which analyze the image information and determine what kind of object the object to be cleaned is.

Provision may be made that the detection unit is a spectroscopic unit for spectroscopically examining the object. Information relating thereto can be evaluated by the at least one control unit to determine the object and/or its quality.

It is advantageous if information about the quality of the object is providable to the at least one control unit or if the quality of the object is determinable by the control unit on the basis of the information transmitted thereto. Here, it is advantageous if, in particular, a material of the object and/or a degree of soiling of the object can be provided or determined. The cleaning recommendation is advantageously providable in dependence on the determined property in order to achieve a best possible cleaning result.

It is favorable if the high pressure cleaning system comprises a storage unit and if a user profile of the user is storable in the storage unit, wherein information linked to the user profile can be taken into account by the at least one control unit for the creation of the cleaning recommendation. By using the user profile, additional information can be provided to the system, which can be utilized for the cleaning recommendation with a view to a best possible cleaning result.

The information linked to the user profile can advantageously underlie the cleaning recommendation and/or the cleaning profile.

It is advantageous if an interface for the user for interacting with the user profile is providable by way of the input unit and the output unit. This makes it possible for the user to manage the user profile and advantageously to supplement same with additional information that can be taken into account by the at least one control unit. It is favorable if the interface can be provided using a user application program (advantageously the app discussed above) of an accessory device, wherein the accessory device comprises the input unit and the output unit.

It is favorable if at least one individualized object to be cleaned is storable, linked to the user profile, in the storage unit, said object being specifiable by the user to the at least one control unit, and if the cleaning recommendation is providable for the individualized object. The high pressure cleaning system thus has a high versatility. The user can store individual objects in his/her user profile and thereby refine recommendations that otherwise can only be provided about generic, identical objects. Here, the preferences of the user for the cleaning of the object can preferably be taken into account, in particular the quality of the individual object as well.

In a preferred embodiment, at least one accessory linked to the user profile and information relating thereto is storable in the storage unit, wherein the cleaning recommendation is providable to the user only on the basis of the stored at least one accessory. The cleaning recommendation can be adapted to the user in this way. Here, only accessories that the user possesses are used. The listing of accessories can take place, e.g., automatically by means of a sensor device, contactlessly by means of chip cards, and/or manually by scanning a code or by inputting a code. In this way, the list of accessories can, for example, be managed by the user and be added to his/her user profile.

Alternatively, provision may be made that at least one accessory is linked to the user profile and information relating thereto is storable in the storage unit, wherein the cleaning recommendation is providable to the user independently of the at least one accessory. Despite the fact that the user does not possess a particular accessory, the cleaning recommendation can suggest the use of said accessory. Here, an interaction element connected to an acquisition request for the accessory can be provided.

Provision is advantageously made that the type of high pressure cleaning appliance is storable, linked to the user profile, in the storage unit and if the cleaning recommendation is providable in dependence on the type of high pressure cleaning appliance. This offers the advantage that the cleaning recommendation can be tailored to the type of high pressure cleaning appliance used by the user. It of course remains reserved to the present invention that a plurality of high pressure cleaning appliances may be linked to the user profile, for example, the user being able to specify the high pressure cleaning appliance or this being automatically detectable. The adapted cleaning recommendation makes it possible, for example, that only accessories and/or values of operating parameters that are compatible with the high pressure cleaning appliance are specified.

Provision may be made that the output unit is of optical configuration and, in particular, comprises an image display for displaying the cleaning recommendation and/or the at least one interaction element. This was already discussed above.

The output unit may alternatively or in addition be of acoustic configuration with a speaker for voice output of the cleaning recommendation and output of the at least one interaction element for the verbal dialogue operation. In response to the voice output, the user can interact with the high pressure cleaning system, for example by means of voice input.

The cleaning recommendation may be transmittable to a control unit of the high pressure cleaning appliance, or the high pressure cleaning appliance may comprise at least one control unit. This was already discussed.

Provision may be made that the value of at least one operating parameter is limitable by the high pressure cleaning appliance in dependence on the accessory contained in the cleaning recommendation. For example, the pressure of the cleaning liquid or a pressure level for the cleaning liquid is limited in dependence on the accessory and/or the object to be cleaned in order to avoid damage to the object.

It is favorable if it is determinable by a control unit of the high pressure cleaning appliance during use thereof which value of at least one operating parameter is used and/or which accessory is used. In particular, the value of at least one operating parameter is limitable by the high pressure cleaning appliance in dependence on the accessory used, which is preferably contactlessly detectable, for example by means of an RFID technology.

It is favorable if it is determinable by the control unit of the high pressure cleaning appliance whether the value of at least one operating parameter and/or the accessory used deviates from the cleaning recommendation, for example upon the start of operation or at a later time. This makes it possible, in particular, to detect a misoperation of the high pressure cleaning appliance and to initiate countermeasures if necessary.

Upon determining the deviation, for example, at least one of the following is performable:
providing an indication to the user, in particular on the high pressure cleaning appliance, the operating unit thereof, and/or on the output unit, for example on the external accessory device;
deactivating the high pressure cleaning appliance or the pump assembly;
changing the value of the at least one operating parameter on the high pressure cleaning appliance, preferably setting the value of the operating parameter in accordance with the cleaning recommendation;
reducing the value of the at least one operating parameter on the high pressure cleaning appliance, provided the value of the operating parameter exceeds the value according to the cleaning recommendation, for example to conform with a maximum predetermined value;
transmitting information relating to the deviation from the cleaning recommendation to a storage unit and storing the information in the storage unit. For example, possible misoperation can be externally checked in this way. It is possible, in particular, to train the user in the use of the high pressure cleaning system. The exclusion of warranty claims in the case of improper use is also conceivable.

It is understood that the components of the high pressure cleaning system may have required communication interfaces for transmitting information among one another and with external devices.

Provision may be made that the high pressure cleaning appliance communicates, in particular wirelessly, with further devices of the user, specifically with further cleaning appliances.

The high pressure cleaning system advantageously comprises a storage unit, wherein usage information of the high pressure cleaning appliance is transmittable by a control unit to the storage unit for storage and is storable therein. For example, a protocol of the usage of the high pressure cleaning appliance can be created.

The use of usage information to detect the consumption of usage components, for example the consumption of cleaning agents and/or the wear of accessories, is conceivable. In this case, for example, reorders can be suggested to the user or be automatically triggered. The usage information may, for example, be analyzed by the at least one control unit or by a spatially remote data processing device and recommendations relating thereto for improving the cleaning behavior may be transmitted to the user.

It may be favorable if information can be transmitted between the high pressure cleaning appliance and an external data processing devices, for example provided by way of a cloud service. The high pressure cleaning appliance can, for example, transmit accessory and appliance information to the data processing device. Commands or settings that, for example, can be performed by the user on the input unit can be transmitted from the latter to the external data processing device and from there, for example, directly to the high pressure cleaning appliance. It is conceivable that the high pressure cleaning appliance can communicate with other devices by way of a computer network, for example a cloud. Alternatively or in addition, provision may be made that a direct point-to-point communication connection exists between two or more devices. All communication connections between components of the high pressure cleaning system and/or to external devices may be of unidirectional or preferably bidirectional configuration.

The high pressure cleaning system may comprise a gateway with which the high pressure cleaning appliance can communicate, for example via WiFi, via Bluetooth, and/or via a ZigBee connection. Further devices, in particular of the user themselves, can be integrated in the network that exists between the gateway and the high pressure cleaning appliance. Alternatively, provision may be made that further devices are integrated in a different kind of network and communicate with the high pressure cleaning appliance by way of the gateway.

It may prove to be favorable if functions of the high pressure cleaning appliance are variable and, in particular, unlockable, by the user by way of the input unit. For example, a function of the high pressure cleaning appliance may be activatable by way of the input unit, specifically the user application program. Provision may be made, for example, that the unlocking or activation takes place only after the input unit establishes a connection with a data processing device in the possession of or under the administration of the manufacturer of the high pressure cleaning system and is coupled to a prior registration with the manufacturer and/or the payment of a fee. It is also conceivable, in particular, that a function of the high pressure cleaning appliance is to be unlocked or activated in order to use a particular accessory as best as possible.

Provision may be made that a firmware stored in the high pressure cleaner is updatable. For example, the update may be triggered by the user by way of the input unit.

Provision may be made that new software is installable on the high pressure cleaning appliance. For example, the user can trigger the installation of new software by way of the input unit.

Provision may be made that it is detected and stored what the usage time (duration and/or periods) for the high pressure cleaning appliance is, which accessories are used, and/or which objects are cleaned.

Optionally, in the case of a high pressure system of the kind stated at the outset, at least one of the following may be provided:
The cleaning recommendation advantageously comprises an instruction for using an accessory and/or the value of at least one operating parameter, and the high pressure cleaning appliance is settable to the value of the at least one operating parameter without prior confirmation or change by the user.
The cleaning recommendation advantageously comprises an instruction for using an accessory and/or the value of at least one operating parameter, and the high pressure cleaning system comprises a storage unit in which a user profile of the user is storable, wherein information linked to the user profile can be taken into account by the at least one control unit for the creation of the cleaning recommendation, wherein an accessory and/or the type of high pressure cleaning appliance is linked to the user profile and information relating thereto is storable in the storage unit and the cleaning recommendation is providable to the user on the basis of the stored at least one accessory and/or the high pressure cleaning appliance. Provision may hereby be made that the cleaning recommendation is providable only on the basis of the stored at least one accessory.
the cleaning recommendation advantageously comprises an instruction for using an accessory and/or the value of at least one operating parameter, and the object to be cleaned is detected by means of a detection unit and information relating thereto is transmitted to the at least one control unit, wherein the control unit is configured to detect the object on the basis of the information transmitted thereto. The cleaning recommendation can be provided in dependence on the result of the determination by the at least one control unit. The detection unit is or comprises, for example, the aforementioned camera for creating at least one image of the object of the high pressure cleaning system. Alternatively or in addition, for example, a different detection of the object may be conceivable, e.g., by means of RFID technology, the use of a code or the like.

The features described above that were highlighted as optional may, in combination with a high pressure cleaning system of the kind stated at the outset, constitute an independent invention within the scope of the present disclosure. Advantageous embodiments of said respective invention may arise on the basis of all features of the present disclosure. These features may also include, in particular, those features that refer to providing the at least one interaction element, preferably in dependence on the cleaning recommendation.

Image content can be displayed on the output unit by the at least one control unit by way of augmented reality (AR). For example, images of the object are supplemented with AR content that can assist the user in setting the high pressure cleaning appliance and/or in performing the cleaning.

The object stated at the outset is achieved by a method in accordance with the invention for operating a high pressure cleaning system, comprising a high pressure cleaning appliance that has a pump assembly, at least one accessory that is in or is bringable into flow connection with a high pressure outlet of the pump assembly, wherein the high pressure cleaning appliance is operable with at least one variable operating parameter, wherein a user specifies an object to be cleaned to a control unit by way of an input unit and the control unit provides a cleaning recommendation on an output unit in dependence on the specification, said cleaning recommendation comprising an instruction for using an accessory and/or the value of at least one operating parameter, wherein at least one interaction element, linked to the cleaning recommendation, for the user is providable on the output unit for transmitting interaction information to the at least one control unit, in particular in dependence on the cleaning recommendation.

The advantages which were already stated in conjunction with the explanation of the high pressure cleaning system in accordance with the invention can also be achieved using the method in accordance with the invention. Reference may be made to the preceding remarks in this regard.

Advantageous embodiments of the method in accordance with the invention result from advantageous embodiments of the high pressure cleaning system in accordance with the invention. Reference may be made to the preceding remarks also in this regard.

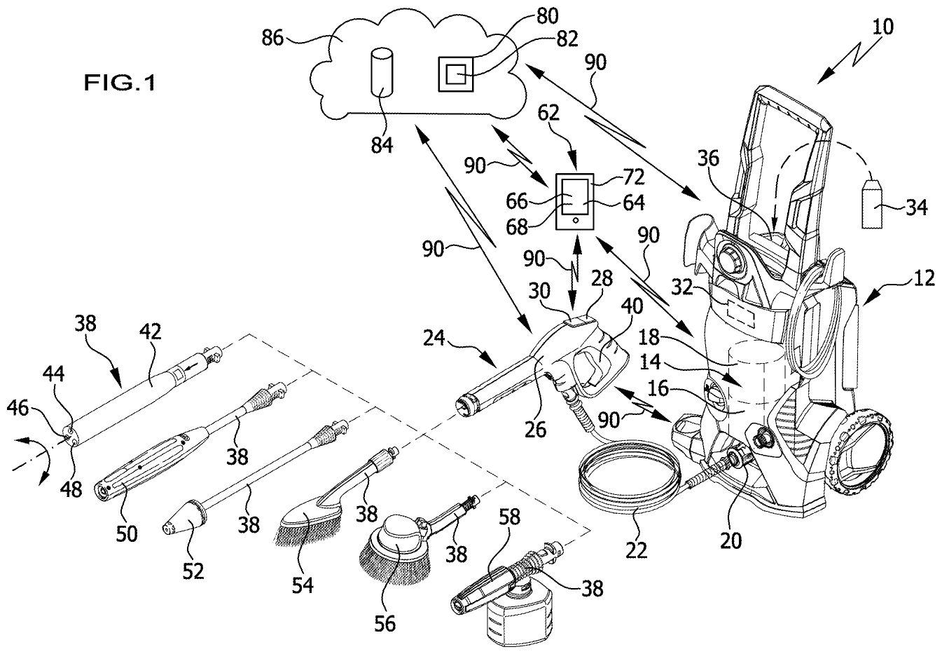

In the following, with reference to the drawing, advantageous embodiments of the high pressure cleaning system in accordance with the invention are described with which in each case advantageous embodiments of the method in accordance with the invention can be performed. Identical reference numerals are used for identical or functionally equivalent features or components. First, a high pressure cleaning system that is depicted in FIGS. 1 to 9 and 11 is discussed.

The advantages that are discussed in the context of this embodiment can also be achieved in the further embodiments, such that reference may be made to the description relating to the first embodiment. In the following, only the significant differences in the various advantageous embodiments are discussed.

FIG. 1 shows schematically a high pressure cleaning system, denoted with the reference numeral 10, in a preferred embodiment. The high pressure cleaning system 10 comprises a high pressure cleaning appliance 12 with a pump assembly 14 that comprises a high pressure pump 16 and a drive motor 18 for the high pressure pump 16.

A high pressure conduit, for example in the form of a hose conduit 22, can be connected to a high pressure outlet 20 of the high pressure pump 16. The hose conduit 22 is further connected to an operating unit 24 in the form of a high pressure gun 26.

An input unit 28 is arranged on the operating unit 24. Further, an output unit 30 may be arranged on the operating unit 24. By way of the input unit 28, a user can, for example, set at least one operating parameter of the high pressure cleaning appliance 12. The operating parameter is, for example, a pressure level at which the pump assembly 14 is operated, wherein the pressure of the dispensed cleaning liquid depends on the pressure level.

FIG. 15, which will be discussed in the following, shows schematically the duplication of an image content of the output unit 30 on the display unit of an external accessory device. The image content, denoted there with the reference numeral 31, comprises the display of the pressure level currently used during operation, this being pressure level “2” in the present example.

By means of virtual keys, presently configured as buttons 331, 332, the pressure during operation of the high pressure cleaning appliance 12 can be varied by the pressure level being incremented or decremented. A virtual key in the form of a button 334 makes it possible to operate the high pressure cleaning appliance 12 temporarily at an increased pressure in a “Boost” operating mode. A display element 335 in this case preferably visualizes to the user how long the “Boost” mode has already been activated or will continue to be activated. For example, an activation of the “Boost” mode for about 10 to 60 seconds may be provided.

In the present case, it is understood that the image content 33 can be displayed on the output unit 30. The high pressure gun 26 may comprise actuation elements, for example in the form of physical keys, corresponding to the buttons 331, 332, and 334. A display element corresponding to the display element 335 may be provided on the output unit 30.

Alternatively or in addition to the pressure level, for example, the admixing ratio of a cleaning chemical to the cleaning liquid may be an operating parameter, wherein the user can specify the admixing ratio by way of the input unit 28. Instructions of the user on the operating unit 24 are, for example, transmitted, in particular wirelessly, to a control unit 32 arranged in the high pressure cleaning appliance 12. The control unit 32 can control the pump assembly 14 to adopt the pressure level.

For admixing the cleaning chemical, a schematically depicted container 34 can be inserted into a receptacle 36 of the high pressure cleaning appliance 12. Depending on the admixing ratio, the control unit 32 can control the pump assembly 14 to admix the desired amount of cleaning chemical.

Feedback from the high pressure cleaning appliance 12 and/or information about the inputs of the user can be displayed on the display unit 30.

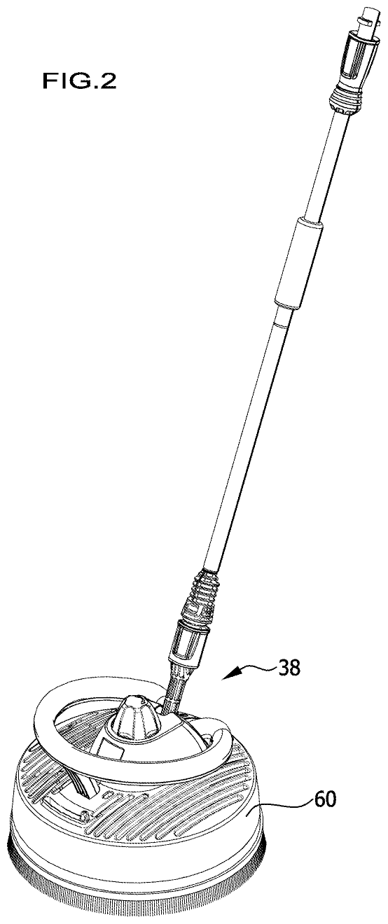

The high pressure cleaning system comprises a plurality of accessories, which are depicted in FIG. 1 and FIG. 2 and are each denoted with the reference numeral 38. Depending on the cleaning task and/or request of the user, an accessory 38 can be releasably connected to the operating unit 24. The cleaning liquid, in particular water, optionally with admixed cleaning chemical, is dispensed from the respective accessory 38 upon the operating unit 24 being actuated by way of a handle 40. In each case, there is a flow connection from the accessory 38 to the high pressure outlet 20.

The drawing depicts as an example the following accessories 38:

Referred to with the reference numeral 42 is a discharge device 42, which presently comprises three discharge units 44, 46, and 48. One of the discharge units 44, 46, or 48 may be used depending on the operating position of the discharge device 42.

The discharge unit 44 comprises, e.g., a flat jet nozzle, the discharge unit 46 a rotor nozzle, and the discharge unit 48 a low pressure cleaning agent nozzle.

A discharge unit with a flat jet nozzle is designated with the reference numeral 50.

The reference numeral 52 designates a discharge unit with a rotor nozzle.

The reference numerals 54 and 56 designate accessories 38 in the form of washing brushes.

The reference numeral 58 designates an accessory 38 in the form of a foam nozzle.

The reference numeral 60 designates an accessory 38 in the form of a surface cleaning device (FIG. 2).

Depending on the cleaning task, i.e., in particular on the object to be cleaned, the use of at least one suitable accessory 38 is advantageous. Here, a best possible cleaning result is desirable, for one. For another, however, damage to the object should be avoided.

To this end, it is advantageous if the user uses at least one suitable accessory 38, in particular in combination with an operating parameter of the high pressure cleaning appliance 12 that is suitable for operating said accessory 38 and for achieving a good cleaning result.

Possible operating parameters that can be set in the high pressure cleaning appliance 12 are, for example, as already mentioned, the pressure level of the pump assembly 14 or the admixing ratio for the cleaning chemical. Further possible operating parameters are, for example, the pressure (absolute pressure) of the cleaning liquid, a volumetric flow of the cleaning liquid or a volume level for the cleaning liquid, a working distance of the accessory 38 from the object to be cleaned, the use of a particular nozzle, for example in the discharge device 42, and/or the use of an operating mode at a temporarily increased pressure (Boost) for the cleaning liquid.

Operating parameters of the high pressure cleaning appliance 12 can be set by the control unit 32 thereof. Here, it is possible, in particular, that information relating to the operating parameters, in particular values of the operating parameters, are transmitted to the high pressure cleaning appliance 12 by way of a communication interface. This was already discussed above with the example of the operating unit 24.

The information transmission to the high pressure cleaning appliance 12 preferably takes place wirelessly. Here, a variety of types of protocols and network architectures with which the person skilled in the art is familiar may be used.

The high pressure cleaning system 10 comprises an external accessory device 62 arranged spatially separate from the high pressure cleaning appliance 12. In the present example, the accessory device 62 comprises an integrated unit 64, which comprises an input unit 66 for the user as well as an output unit 68 for the user. The integrated unit 64 comprises the input unit 66 and the output unit 68 in a common housing 70. In the present example, the accessory device 62 is configured as a smartphone 72.

An integrated input/output unit in the form of a touchscreen 74 is provided. Correspondingly, the output unit 68 is of optical configuration with an image display for providing visual information for the user. The input unit 66 is of touch-sensitive configuration.

It is understood that the input unit 66 is alternatively or additionally of optical and/or acoustic configuration, for example for a voice input, and the output unit is alternatively or additionally of acoustic configuration with the possibility of voice output.

The accessory device 62 comprises a control unit 76 and a storage unit 78. Stored in the storage unit 78 is a user application program, configured as an app. The user application program can be executed by the control unit 76 and enables the user to interact with the high pressure cleaning system 10 in an intuitive manner. In particular, cleaning recommendations on the basis of the object to be cleaned can be requested by the high pressure cleaning system 10 and the high pressure cleaning appliance 12 can be automatically and/or manually set for operation by way of the accessory device 62.

In a preferred embodiment, the exchange of information between the accessory device 62 and the high pressure cleaning appliance 12 takes place by way of a point-to-point connection, for example by means of Bluetooth. In a different advantageous embodiment, provision may be made that the high pressure cleaning appliance 12 and the accessory device 62 communicate in a common network. For example, a ZigBee network is used, which is provided by a Gateway that is not depicted in the drawing and which itself can communicate by way of wireless network with a home network router, which in turn enables an internet connection.

In a preferred embodiment, the high pressure cleaning system 10 further comprises a data processing device 80 arranged spatially remote from the high pressure cleaning appliance 12 and from the accessory device 62, which data processing device 80 may itself have a control unit 82. Further, a storage unit 84 may be arranged spatially remote. It is understood that the storage unit 84 can be formed by or integrated into the data processing device 80, in particular the control unit 82. The same applies to the storage unit 78 and the control unit 76.

In the present example, the data processing device 80 and the storage unit 84 are implemented by means of a symbolically depicted cloud service 86. In this case, the cloud service 86 may be, in particular, a plurality of data processing devices that are in communication connection with one another.

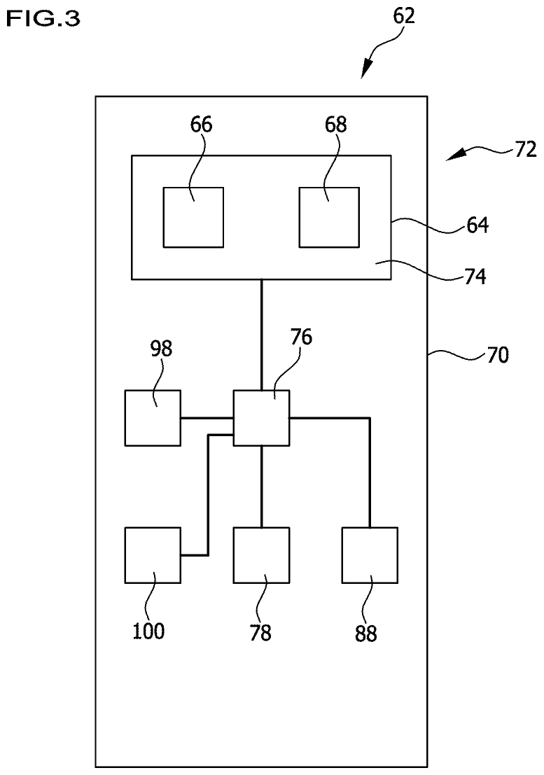

The data processing device 80 may be in or enter into communication connection with the accessory device 62. As an example, FIG. 3 indicates with the reference numeral 88 a communication member of the accessory device 62 for providing a communication interface.

Double arrows 90 in FIG. 1 indicate schematically communication connections between the different components of the high pressure cleaning system 10, namely the high pressure cleaning appliance 12, the operating unit 24, the accessory device 62, and the data processing device 80 or the cloud service 86. A data exchange thereby takes place preferably wirelessly and/or bidirectionally. All protocols and/or networks with which the person skilled in the art is familiar may be used. The use of point-to-point connections is conceivable.

The high pressure cleaning system 10 may, alternatively or in addition to the accessory device 62, comprise further and/or different accessory devices. It is conceivable, for one, that a plurality of accessory devices 62 of the same kind are used, for example different smartphones 72.

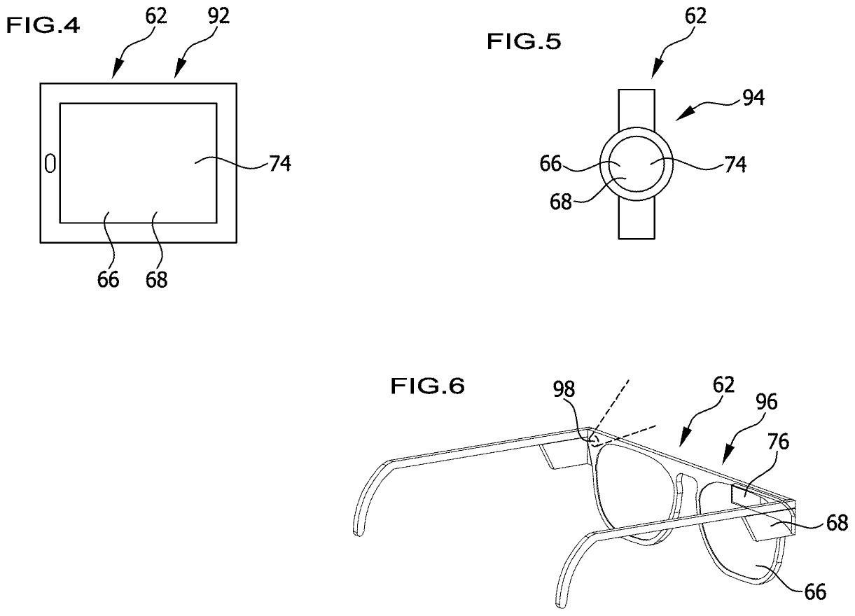

For another, it is conceivable that accessory devices 62 of different kinds are used. Examples of this are depicted in FIGS. 4 to 6.

FIG. 4 shows an accessory device 62, configured as a tablet computer 92. FIG. 5 shows an accessory device 62, configured as a smartwatch 94. FIG. 6 shows an accessory device 62, configured as a head-mounted device, in particular in the form of data glasses 96.

It is understood that the functions described with the example of the smartphone 72 can also be implemented in the case of the tablet computer 92, the smartwatch 94, and the data glasses 96. In the case of the data glasses 96, the output unit 68 is configured, in particular, as a display arranged in the field of view of the user for visually displaying information. The input unit 66 is, in particular, of verbal configuration. An optical input unit 66 may preferably be provided.

An optical input unit 66 may have, e.g., a camera and, in particular, digital camera 98, which may also be provided in the case of the smartphone 72. The input unit 66 may have, e.g., a different kind of detection unit with which the object to be cleaned is detectable, for example by means of RFID technology. The reference numeral 100 designates a corresponding detection unit in FIG. 3.

The interaction of the user with the high pressure cleaning system 10 for obtaining a cleaning recommendation may take place by way of the accessory device 62 with a user application program, for example in one of the manners described in the following.

For example, it is described how the control unit 76, the control unit 82, or the control unit 32 can process information. Here, provision may be made, in particular, that the processing of information, for example the provision of cleaning recommendations, the receipt of interaction information and/or the forwarding thereof, is performed by only one of the control units or a combination of two or more control units, which may each be used for this purpose. For example, the cleaning recommendation is provided by the control unit 82 and transmitted to the accessory device 62. Possible interaction information can be detected by the control unit 76 of said accessory device and, for example, be transmitted directly or indirectly to the control unit 32 of the high pressure cleaning appliance 12 and/or the control unit 82.

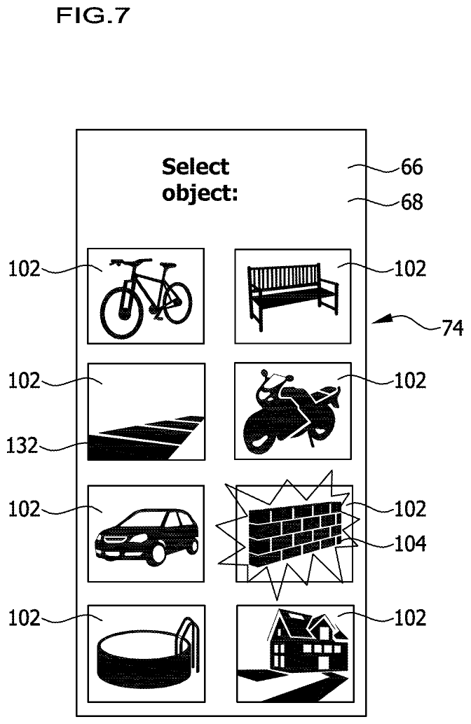

The selection of the object to be cleaned can be carried out by way of the app. The exemplary representation of FIG. 7 shows using pictograms 102 a plurality of objects to be cleaned in generic form. The objects are, for example, a selection of objects that are typically cleaned with the high pressure cleaning appliance 12.

The pictograms 102 displayed on the touchscreen 74 can be selected by the user. In the present example, it is assumed that the user touches the pictogram separately referenced with the reference numeral 104, said pictogram showing a wall or the like as an object to be cleaned.

The user then obtains a cleaning recommendation, presently by displaying on the display unit 68 of the touchscreen 74. To this end, the input is transmitted to a control unit of the high pressure cleaning system 10. For example, the control unit 82 is used for this purpose. The control unit 82 can load a cleaning profile stored in the storage unit 84. In a respective cleaning profile, it is stored, linked to the object to be cleaned, which accessory 38 and which values of operating parameters of the high pressure cleaning appliance 12 should preferably be used.

The corresponding cleaning recommendation can be transmitted by the control unit 82 to the accessory 62.

Alternatively or in addition, it is conceivable that the cleaning recommendation is provided by the control unit 32 or 76. Cleaning profiles can be stored, e.g., in the storage unit 78 of the accessory device 62.

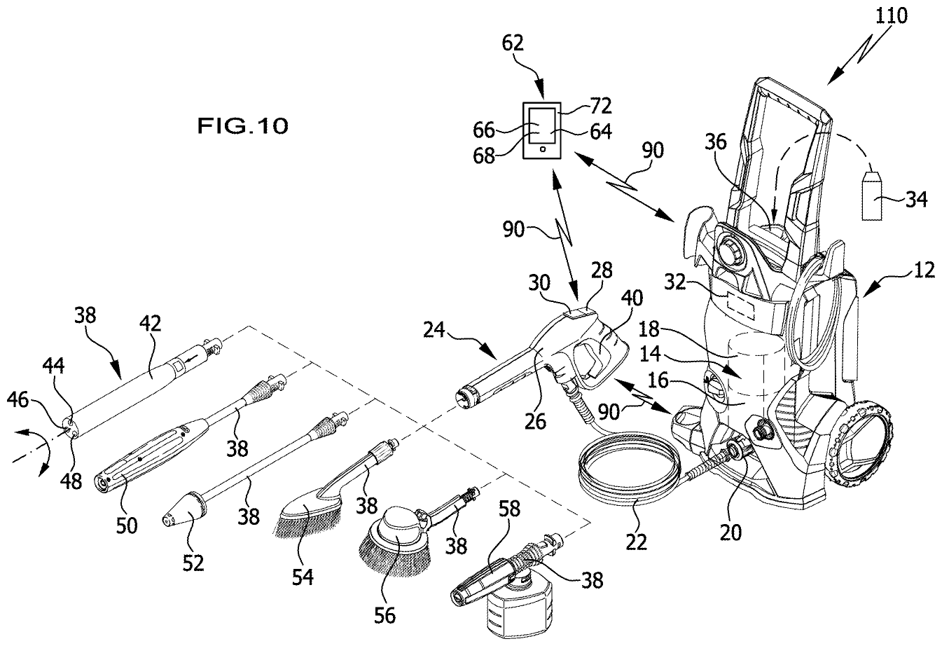

In the case of a high pressure cleaning system of that kind, provision may be made that the external data processing device 80 and the storage unit 84 are omitted. Such a high pressure cleaning system in accordance with the invention is depicted in FIG. 10 in a manner corresponding to FIG. 1 and is denoted there with the reference numeral 110.

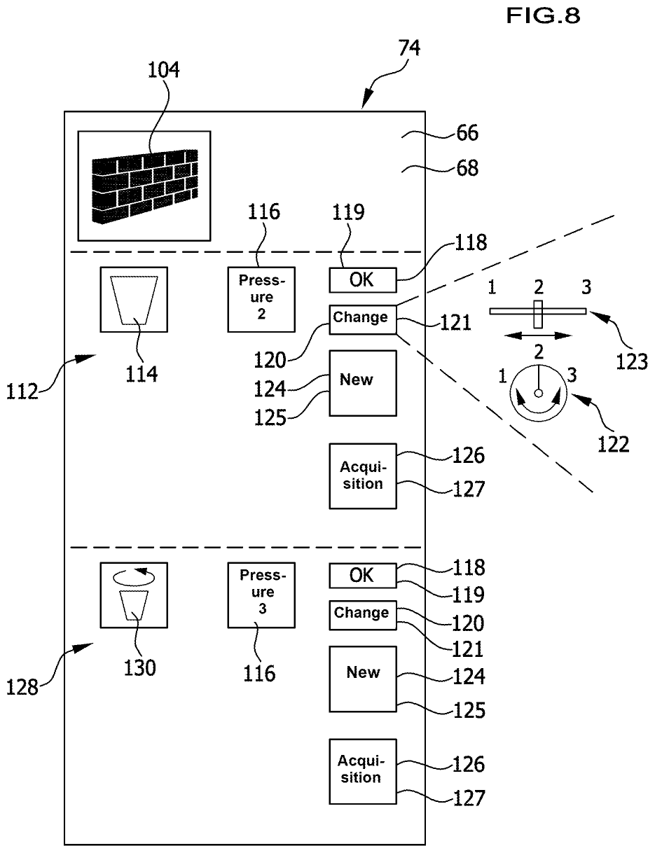

FIG. 8 schematically shows, denoted with the reference numeral 112, a cleaning recommendation for the user displayed on the output unit 68. Linked to the pictogram 104, for example, an accessory 38 suggested by the control unit 82 is displayed. Said pictogram is a pictogram of the discharge unit 50 or 44. Correspondingly, the user is notified that a flat jet nozzle should advantageously be used. The pictogram bears the reference numeral 114.

It is favorable if, in addition, the value of at least one operating parameter is comprised by the cleaning recommendation 112. In the present case, it is shown by way of a symbol 116 that the pressure level 2 of the high pressure cleaning appliance 12 should advantageously be used.

In the present invention, it is favorable that, in addition, at least one interaction element for the user is provided with the cleaning recommendation 112. In the present case, an interaction element 118 for the user is displayed as a constituent part of the cleaning recommendation 112. The interaction element 118 is a confirmation element 119. By actuating the confirmation element 119, interaction information is transmitted to the control unit 32, 76, or 82.

In the present case, the interaction information may be merely an acknowledgment of the user that he/she acknowledges the recommendation for the value of the operating parameter “pressure”.

It is favorable if a setting of the high pressure cleaning appliance 12 in accordance with with the cleaning recommendation 112 is performed upon confirmation by the user. Here, in particular, the pressure level can be set to the value 2.

The interaction information of the user relating thereto can be transmitted directly or indirectly to the high pressure cleaning appliance 12 upon actuation of the confirmation element 119. For example, the control unit 76 receives the information and transmits it to the control unit 32, by which the pressure level is set according to the cleaning recommendation 112.

The transmission of the information to the high pressure cleaning appliance 12 may be effected by the accessory device 82 or by the data processing device 80 without or with intervention by the user.

A further interaction element 120 is configured as a changing element 121. By actuating the changing element 121, for example, a rotary or slide control 122 and 123, respectively, (on the right in FIG. 8) can be displayed for the user. Using one of the controls 122, 123, the user can specify a desired pressure level. The value thereof can preferably be transmitted to the high pressure cleaning appliance 12 and the latter can be automatically set without further intervention by the user.

For example, an interaction element 124 may be provided as a constituent part of the cleaning recommendation 112. The interaction element 124 is a request element 125. By actuating the request element 125, the user can transmit interaction information to the control unit 82 with the request for the provision of a different cleaning recommendation. Said cleaning recommendation can then also be provided on the output unit 68.

A further interaction element 126 may be provided as a constituent part of the cleaning recommendation 112. In the present case, the interaction element 126 is an acquisition element 127. By actuating the acquisition element 127, the user can transmit an acquisition request to the data processing device 80. This is advantageous, for example, when the user is not in possession of the accessory 38 suggested according to the cleaning recommendation 112.

The control unit 82 can provide a plurality of cleaning recommendations in response to the cleaning request of the user. In addition to the cleaning recommendation 112, a further cleaning recommendation 128 is depicted exemplarily in FIG. 8. By way of a pictogram 130, the rotor nozzle 46 or the discharge unit 52 with a rotor nozzle is suggested as an accessory 38. Level 3 is suggested as the pressure level for the operating parameter “pressure”.

The cleaning recommendation 128, too, may comprise the interaction elements 118, 120, 124, and 126.

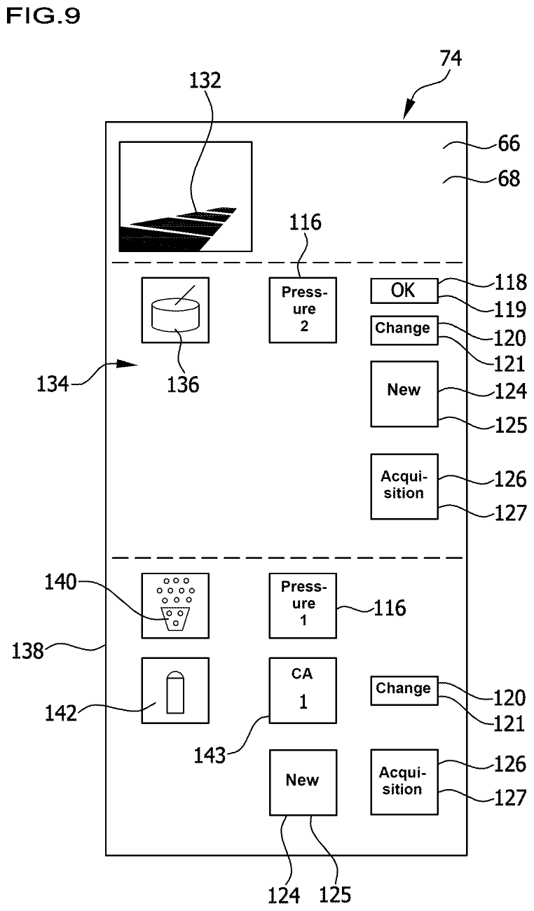

FIG. 9 shows a further example of cleaning recommendations that can be provided to the user by way of the output unit 68 of the touchscreen 74. Here, it is assumed that the user selected and transmitted as the object to be cleaned the pictogram, referenced with the reference numeral 132, in which a path covered with stone tiles is depicted.

A cleaning recommendation 134 suggests by means of the pictogram 136 the use of the surface cleaning device 60 as an accessory 38. The pressure level 2 is suggested as the value for the operating parameter “pressure”.

A further cleaning recommendation 138, for example for pre-cleaning, suggests by means of the pictogram 140 the discharge unit 48 with the low pressure cleaning agent nozzle as an accessory 38. Moreover, the use of the container 34 with a cleaning chemical is suggested with the pictogram 142.

Level 1 is suggested for the operating parameter “pressure”. Level 1 is suggested for the operating parameter “admixing ratio” (symbol 143).

In the case of the cleaning recommendations that are exemplarily depicted in FIG. 9, as well, the user can transmit interaction information by means of the interaction elements 118, 120, 124, and 126.

By way of the at least one interaction element 118, 120, 124, and 126, in combination with the feedback of the control unit 82, 76, or 32 by way of the output unit 68, a dialogue of the user with the high pressure cleaning system 10 is possible. A cleaning recommendation can thereby be presented to the user in order to achieve a best possible cleaning result. At the same time, the user can be instructed to operate the high pressure cleaning appliance 12. It can thereby advantageously be ensured that the object to be cleaned is not damaged. For example, only an accessory 38 that does not cause any damage to the object is suggested.

For the purpose of the latter, it may be advantageous if the value of at least one operating parameter of the high pressure cleaning appliance 12 is limited in dependence on the accessory 38 that is suggested or used.

Provision may be made that the accessory 38 that is used and the value of at least one operating parameter is detected and, in particular, monitored. For example, misoperation by the user can be caught by the high pressure cleaning appliance 12 or the pump assembly 14 being deactivated upon deviation from the cleaning recommendation. Alternatively or in addition, an indication can be provided to the user, for example on the high pressure cleaning appliance 12, on the operating unit 24, and/or on the output unit 68. Alternatively or in addition, the value of at least one operating parameter of the high pressure cleaning appliance 12 can be automatically set to the value in accordance with the cleaning recommendation. It can thereby be ensured, in particular, that a maximum value for the operating parameter is not exceeded.

In the case of misoperation, information relating to the use of the accessory 38 and the value of at least one operating parameter can be detected and, for example, transmitted to the storage unit 84 or 78 for storage. In dependence thereon, possible warranty exclusions may follow. It is also favorable if suggestions for improving the cleaning can be presented to the user.

Irrespective of possible misoperation, provision is favorably made that usage information from the high pressure cleaning appliance 12 can be transmitted and stored in one of the storage units 84 and 76, for example the usage duration, usage times, the use of the accessories 38, and/or values for at least one operating parameter.

In place of the above-described specification of the object to be cleaned by way of one of the pictograms 102, provision may be made that the app on the input unit 66 provides, for example, a text field for inputting the object, a selection list, or a depiction of the actual object.

For example, for the latter case, provision may be made, in particular, that a user profile for the user is stored in a storage unit 78 or 84. Linked to the user profile is, e.g., at least one individualized object to be cleaned. For example, not only a generic object “motor vehicle” is saved in the storage unit 78, 84 linked to the cleaning profile, but the actual object “motor vehicle of the user”.

In particular, information as to what quality the object has, for example which material, can be stored, linked to the individualized object. An optimized cleaning recommendation can be outputted in dependence on the quality.

In providing a user profile for the user, the information as to which accessories 38 the user possesses may be stored linked to said user profile. Provision may be made that the cleaning recommendation only considers those accessories 38 that the user actually possesses and are linked to his/her user profile. Cleaning recommendations that the user cannot implement can be avoided in this way.

Otherwise, provision may be made that the cleaning recommendation is provided independently of the saved accessories 38, here, in particular, the interaction element 126 as an acquisition element 127 being of importance for the user to acquire an accessory 38 that is not present.

The type of high pressure cleaning appliance 12 of which the user is in possession is advantageously saved in the user profile. The cleaning recommendations can be provided by the control unit 82, 76, or 32, preferably in dependence on the type of high pressure cleaning appliance 12 that is saved in order to ensure that accessories 38 are suggested which are compatible with the high pressure cleaning appliance 12.

Upon acquisition of the high pressure cleaning appliance 12, one or more accessories 38 may be a constituent part of basic equipment. By adding the high pressure cleaning appliance 12 to the user profile, it is possible in this way to automatically save in the user profile which accessories 38 the user possesses. These accessories 38 do not have to be further entered in the user profile.

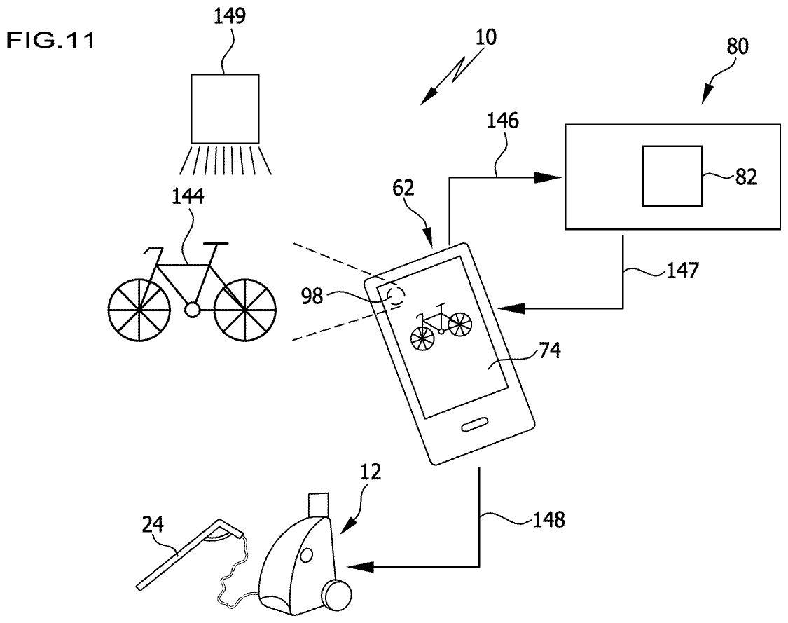

FIG. 11 again shows the high pressure cleaning system 10 in a schematic, simplified representation. In this case, an automatic detection of the object to be cleaned, here, e.g., a bicycle 144, is used.

By means of the digital camera 98, an image of the bicycle 144 can be created. Image information relating thereto is forwarded from the accessory device 62 to the control unit 82.

Stored in the storage unit 82 are image processing algorithms, on the basis of which the object can be identified as a bicycle 144. The quality of the bicycle 144 can preferably also be determined, for example the material thereof and/or the degree of soiling thereof.

On the basis of the determined information, the control unit 32, 76, or 82 can provide a cleaning recommendation on the accessory device 62. The information required for the cleaning recommendation may, for example, be correlated in the control unit 82. Otherwise, provision may be made that the information that the object is a bicycle 144 is transmitted to the accessory device 62, from which the information required for the cleaning recommendation are correlated.

Values for the at least one operating parameter can be transmitted from the accessory device 72 or from the control unit 76 or 82 directly or indirectly to the high pressure cleaning appliance 12.

At least one operating parameter can advantageously be set automatically on the high pressure cleaning appliance 12. The arrows denoted with the reference numerals 146, 147, and 148 schematically and exemplarily illustrate the course of the procedure.

Provision may alternatively be made that the control unit 76 directly analyzes the image information and determines that the object is a bicycle 144. The cleaning recommendation can be transmitted by the control unit 76 on the basis of this information and preferably be transmitted to the high pressure cleaning appliance 12 for setting at least one operating parameter.

FIG. 11 shows a detection unit denoted with the reference numeral 149, which is presently formed separately from the accessory device 62. The detection unit 149 makes it possible to gather information on the object and to transmit same to one of the control units 32, 76, or 82 for determining what said object is and/or the quality thereof. For example, the detection unit 149 is a spectroscopic unit. On the basis of the transmitted information, it can be determined that the object is a bicycle 144 and/or the quality thereof.

Provision may be made, in particular, that the quality of the object can be determined on the basis of the information from one of the detection units 100, 149, or 98, in the form of the digital camera. On the basis of the transmitted information, the control unit can determine, e.g., of what material the object consists. In dependence on the quality, the cleaning recommendation can be provided with a view to a best possible cleaning result.

Alternatively to the optical detection of the object to be cleaned, a different kind of detection may be conceivable. For example, a detection by means of RFID technology is used.

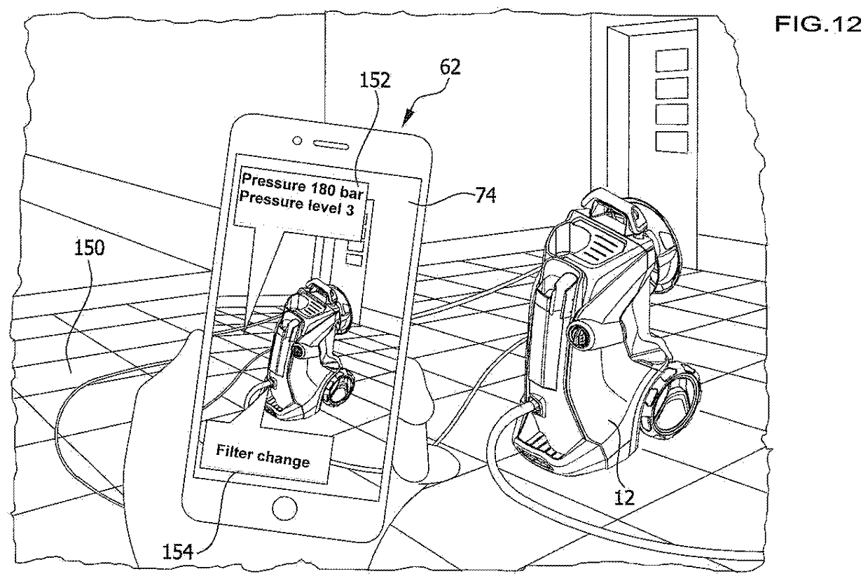

FIG. 12 shows the accessory device 62 in a further application of the high pressure cleaning system 10. Here, a patio 150 is used as the object to be cleaned. The patio 150 is optically detected by means of the digital camera 98. Image information relating thereto is processed by the control unit 82. A corresponding cleaning recommendation is provided on the accessory device 62.

In the example depicted in FIG. 12, the cleaning recommendation is provided by means of augmented reality by overlaying image information 152 as to at what pressure the patio is to be cleaned.

Moreover, a guide for the user for handling and, in particular, for servicing the high pressure cleaning appliance 12, which has also been detected by the digital camera 98, is provided by means of image information 154.

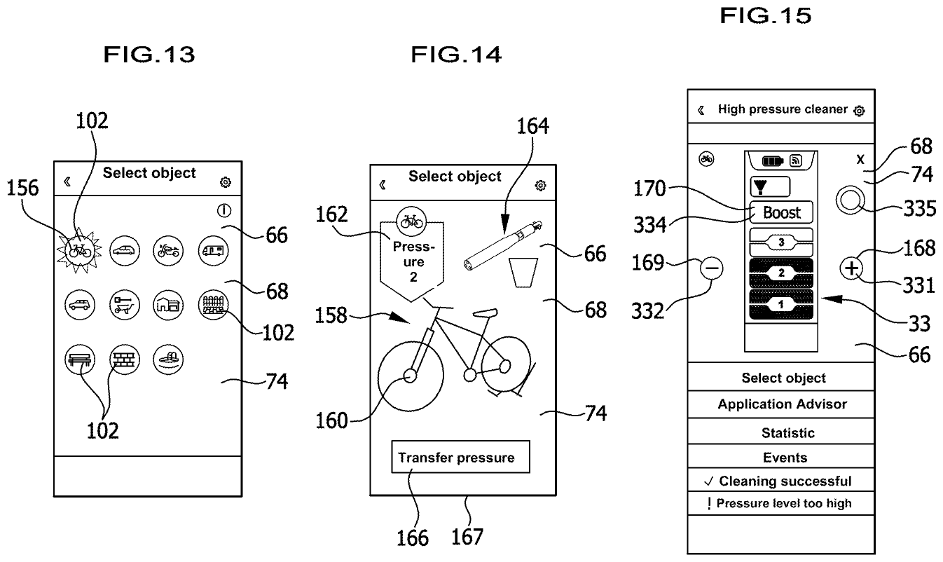

In the following, an exemplary implementation of the high pressure cleaning system 10 in accordance with the invention is discussed with reference to FIGS. 13 to 28. Here, the functions of the high pressure cleaning system 10 can be implemented according to one of the manners described above. First, with reference to FIGS. 13 to 15, a possible configuration of a user application program (app) of the accessory device 62 is discussed. Subsequently, a possible configuration of the app of the accessory device 62 is discussed, which may selectively be used instead of the first described configuration.

FIG. 13 shows the image content of the touchscreen 74 in a manner corresponding to FIG. 7, with the pictograms 102 of the objects to be cleaned. In the present case, the pictogram 156 is selected as an example. The user thereby specifies that the object to be cleaned is a bicycle.

The control unit 82, 76, or 32 then provides a cleaning recommendation 158 on the touchscreen 74. The cleaning recommendation 158 comprises a symbol 160 of the bicycle and a symbol 162 of a value for the operating parameter. In the present case, said operating parameter is the pressure of the cleaning liquid. It is suggested to use the pressure level “2”.

Furthermore, the cleaning recommendation 158 comprises a pictogram 164 of the suggested accessory 38. In the present case, the pictogram 164 depicts the discharge device 42 in its use as a flat jet nozzle of the discharge unit 44. Alternatively, the discharge unit 50 could be used.

The cleaning recommendation 158 further comprises an interaction element 166 that is configured as a confirmation element 167. By actuating the confirmation element 167, the high pressure cleaning appliance 12 is set to the pressure level 2 (FIG. 14), wherein the transmission of the information relating thereto may take place directly or indirectly.

FIG. 15 shows the image display of the touchscreen 74 during operation. As already explained, the image content 33 of the output unit 30 of the high pressure gun 26 is mirrored for the user in a way that is easy to handle. The buttons 331, 332, and 334 form interaction elements 168, 169, and 170, respectively. By the actuation thereof, the user can increment the pressure level (331), decrement the pressure level (332), or temporarily activate the “Boost” mode (334).

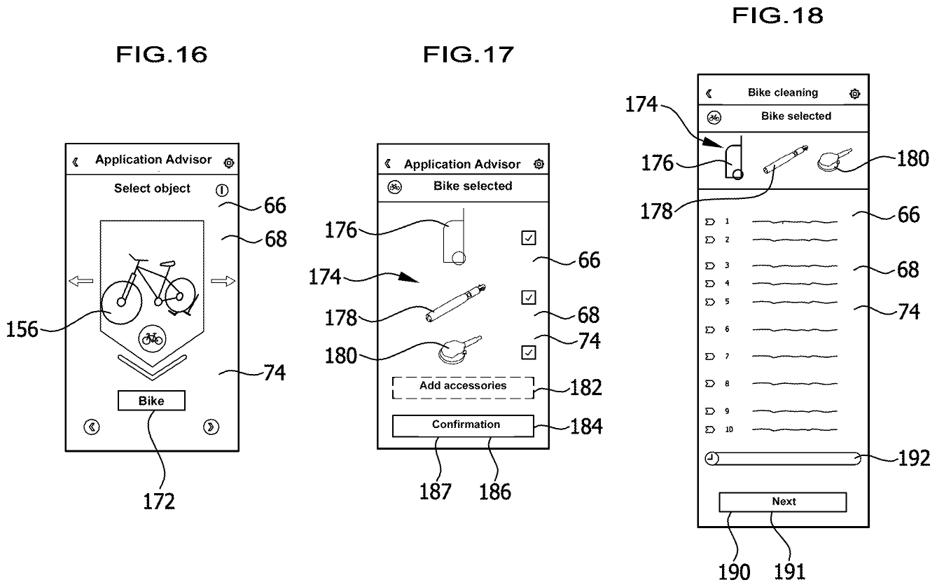

In FIGS. 16 to 28 a functionality of the app of the accessory device 62 is symbolized on the touchscreen 74 as an example.

The user can first select the object to be cleaned (FIG. 16). To this end, as an example, the pictogram 156 with the bicycle is depicted on the touchscreen 74. By “swiping” right and left, it is possible for the user to select a different cleaning object.

Upon actuation of a button 172, a cleaning recommendation 174 is provided on the touchscreen 74 by way of the control unit 82, 76, or 32 (FIG. 17). In the present case, the cleaning recommendation 174 is created, in particular, on the basis of the information of the user profile. Stored in the user profile is the type of high pressure cleaning appliance 12 and which accessories 38 the user possesses.

The cleaning recommendation 174 comprises symbols 176, 178, and 180 of the high pressure cleaning appliance 12 to be used and the accessories 38. Here, the arrow 178 symbolizes the discharge device 42 and the symbol 180 symbolizes the washing brush 56. A button 182 makes it possible for the user to manage the user profile and to save further accessories 38 in his/her profile if necessary.

A further button 184 forms an interaction element 186 as a constituent part of the cleaning recommendation 174. The interaction element 186 is a request element 187. Upon actuation thereof, the user transmits the interaction information for providing a step-by-step guide with cleaning instructions for cleaning the bicycle. The interaction information is transmitted to the control unit 82, 76, or 32, cleaning recommendations then being displayed on the touchscreen 74 in steps (FIGS. 18 to 28).

The cleaning recommendation 174 comprises cleaning instructions 194. A respective cleaning instruction 194 is displayed on the touchscreen 74 together with a further interaction element 190 in the form of a request element 191. The request element 191, upon being actuated by the user, in each case triggers the transmission of interaction information with the goal of providing the subsequent cleaning instruction. At the end, the guide is ended by means of the interaction element 190.

Initially, it may be advantageous to display to the user a summary of the preferred procedure of cleaning the bicycle on the touchscreen 74 (FIG. 18). The individual cleaning steps are thereby ordered in the suggested sequence and are labeled incrementally with “1, 2, 3 . . . 10”.

The estimated cleaning duration can be displayed to the user, e.g., by means of a symbol 192.

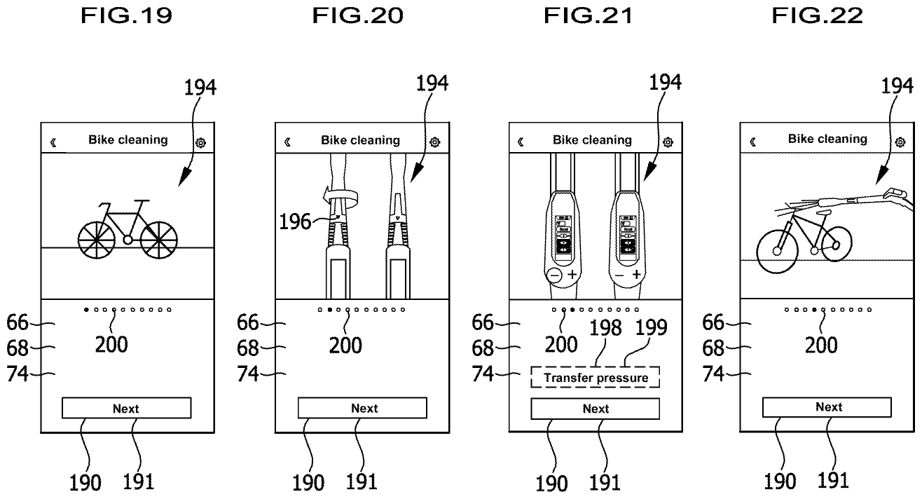

After actuating the request element 191, the cleaning instructions, which are depicted as an example on the basis of FIGS. 19 to 28 and are each denoted with the reference numeral 194, are displayed. Here, in a preferred embodiment of the invention, graphic representations on the touchscreen 74 are used. An instruction in text form and/or by voice output may alternatively or additionally be provided.

The first cleaning instruction 194 according to FIG. 19 instructs the user to suitably position the cleaning object, in the example the bicycle.

The second cleaning instruction 194 according to FIG. 20 instructs the user to use the discharge device 42 with the discharge unit 44 as an accessory, recognizable by the use of the symbol 196 for the flat jet nozzle.

The third cleaning instruction 194 according to FIG. 21 instructs the user to set the operating parameter “pressure” to the value “2” by actuating the button 332 on the touchscreen 74 or alternatively on the high pressure gun 26. When using the touchscreen 74, the value of the operating parameter can be transmitted to the high pressure cleaning appliance 12 by way of an interaction element 198 in the form of a request element 199 and can be automatically set by said high pressure cleaning appliance 12.

The fourth cleaning instruction 194 according to FIG. 22 instructs the user to clean the bicycle first by means of the flat jet nozzle.

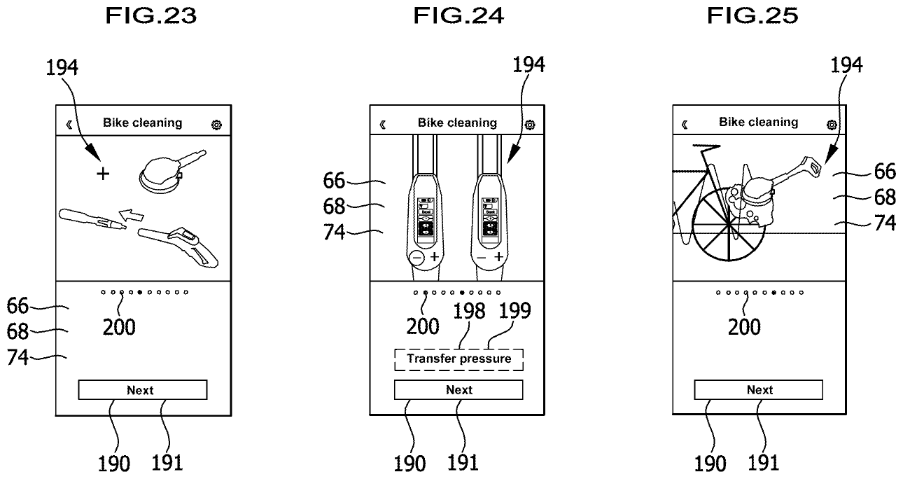

The fifth cleaning instruction 194 according to FIG. 23 instructs the user to exchange the discharge device 42 for the washing brush 56 in order to continue the cleaning with same.

The sixth cleaning instruction 194 according to FIG. 24 instructs the user to set the value for the operating parameter “pressure”, if necessary, to the level “2”. In this case, too, it is possible to transmit the value using the request element 199 to the high pressure cleaning appliance 12.

The seventh cleaning instruction 194 according to FIG. 25 instructs the user to clean the bicycle with the washing brush 56 and to hereby move same over all components of the bicycle.

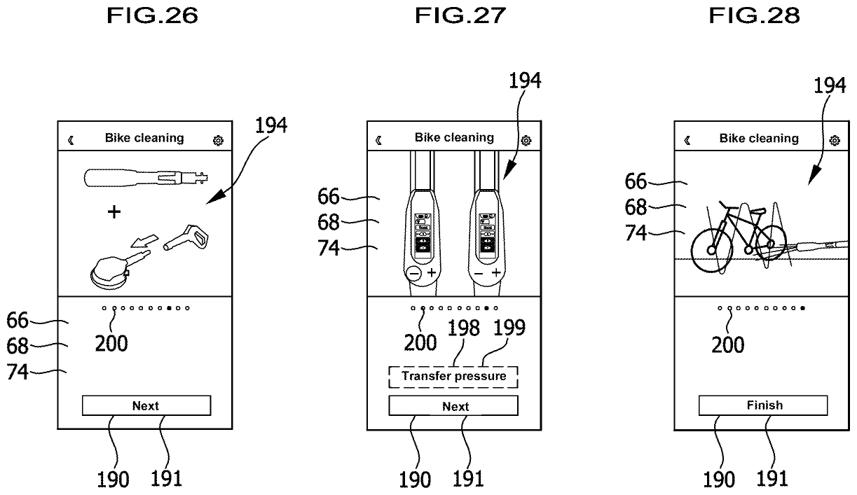

The eighth cleaning instruction 194 according to FIG. 26 instructs the user to exchange the washing brush 56 for the discharge device 42 in order to continue the cleaning with same.

The ninth cleaning instruction 194 according to FIG. 27 instructs the user to again set the cleaning parameter “pressure” to the level “2” if necessary, optionally using the request element 199.

The tenth cleaning instruction 194 according to FIG. 28 instructs the user to conclude the cleaning of the bicycle using the discharge device 42, specifically the flat jet nozzle.

A progress element 200, which can preferably be displayed during each of the cleaning steps, illustrates to the user in an intuitive manner how far the cleaning has progressed.

It is understood that a guide for cleaning the object can be provided in a different manner than was explained above as an example with reference to FIGS. 18 to 28.

It is understood that a cleaning recommendation and a guide for cleaning the object can be provided even when no communication between the accessory device 62 and the high pressure cleaning appliance 12 is possible.

### REFERENCE NUMERAL LIST

10 high pressure cleaning system
12 high pressure cleaning appliance
14 pump assembly
16 high pressure pump
18 drive motor
20 high pressure outlet
22 hose conduit
24 operating unit
26 high pressure gun
28 input unit
30 output unit
32 control unit
33 image content
331 button
332 button
334 button
335 display element
34 container
36 image
38 accessory
40 handle
42 discharge device
44, 46, 48, 50, 52, 54, 56 washing brush
58 foam nozzle
60 surface cleaning device
62 accessory device
64 integrated unit
66 input unit
68 output unit
70 housing
72 smartphone
74 touchscreen
76 control unit
78 storage unit
80 data processing device
82 control unit
84 storage unit
86 cloud service
88 communication member
90 double arrow
92 tablet computer
94 smartwatch
96 data glasses
98 digital camera
100 detection unit
102, 104 pictogram
110 high pressure cleaning system
112, 128, 134, 138 cleaning recommendation
114, 130, 132, 136, 140, 142 pictogram
116, 143 symbol
118, 120, 124, 126 interaction element
119 confirmation element
121 changing element
122 rotary control
123 sliding control
125 request element
127 acquisition element
144 bicycle
146, 147, 148 arrow
149 detection unit
150 patio
152, 154 image information
156 pictogram
158 cleaning recommendation
160, 162 symbol
164 pictogram
166, 168, 169, 170 interaction element
167 confirmation element
172 button
174 cleaning recommendation
176, 178, 180 symbol
182, 184 button
186, 190 interaction element
187, 191 request element
192 symbol
194 cleaning instruction
196 symbol
198 interaction element
199 request element
200 progress element

1. High pressure cleaning system, comprising a high pressure cleaning appliance that has a pump assembly, at least one accessory that is in or is bringable into flow connection with a high pressure outlet of the pump assembly, wherein the high pressure cleaning appliance is operable with at least one variable operating parameter, an input unit, at least one control unit coupled to the input unit, and an output unit coupled to the at least one control unit, wherein an object to be cleaned is specifiable by way of the input unit and a cleaning recommendation is providable on the output unit by the at least one control unit in dependence on the specification, said cleaning recommendation comprising an instruction for using at least one of an accessory and a value of at least one operating parameter, and wherein at least one interaction element is providable for the user, linked to the cleaning recommendation, on the output unit for transmitting interaction information to the at least one control unit, in particular in dependence on the cleaning recommendation.

2. High pressure cleaning system in accordance with claim 1, wherein the at least one interaction element is providable in the form of a button, a selection element, or a rotary or slide control on the output unit, wherein the output unit is a display unit on which the at least one interaction element is displayable.

3. (canceled)

4. (canceled)

5. High pressure cleaning system in accordance with claim 1, wherein the at least one interaction element comprises a confirmation element by the actuation of which a confirmation information of the user is transmittable to the at least one control unit.

6. High pressure cleaning system in accordance with claim 1, wherein the cleaning recommendation comprises an indication relating to the value of at least one operating parameter and wherein the high pressure cleaning appliance is settable to the value of the at least one operating parameter upon confirmation by the at least one interaction element.

7. (canceled)

8. (canceled)

9. High pressure cleaning system in accordance with claim 1, wherein a plurality of cleaning recommendations are providable connected to a respective at least one interaction element and wherein the cleaning recommendations comprise at least one instruction relating to the use of an accessory, wherein the accessories of different cleaning recommendations differ from one another, and wherein the respective at least one interaction element forms a confirmation element or a selection element, upon the actuation of which information for using the accessory linked to said interaction element is transmittable to the control unit.

10. High pressure cleaning system in accordance with claim 1, wherein the high pressure cleaning appliance is settable to the value of the at least one operating parameter, even without prior confirmation or change by the user.

11. (canceled)

12. (canceled)

13. High pressure cleaning system in accordance with claim 1, wherein the at least one interaction element together with the cleaning recommendation is providable on the output unit.

14. (canceled)

15. High pressure cleaning system in accordance with claim 1, wherein the cleaning recommendation comprises a plurality of accessories for use in chronological succession according to cleaning instructions that are providable on the output unit by the at least one control unit.

16. High pressure cleaning system in accordance with claim 1, wherein the at least one interaction element comprises a request element, upon actuation of which by the user at least one cleaning instruction particular a guide, for cleaning the object is providable on the output unit by the at least one control unit.

17. High pressure cleaning system in accordance with claim 16, wherein successive cleaning instructions are providable on the output unit in the form of a step-by-step guide for the user for cleaning the object.

18. High pressure cleaning system in accordance with claim 17, wherein the cleaning instructions are providable for the user with respective interaction elements, wherein the cleaning instruction according to the subsequent step of the guide is providable upon actuation of an interaction element.

19. High pressure cleaning system in accordance with claim 16, wherein cleaning instructions that are providable on the output unit are or comprise at least one of the following:
instruction for setting the high pressure cleaning appliance using the input unit;
instruction for transmitting a value of an operating parameter to the high pressure cleaning appliance;
instruction for guiding an accessory upon cleaning the object;
instruction for connecting an accessory to an operating element or the high pressure cleaning appliance, for disconnecting an accessory, or for exchanging an accessory;
instruction relating to the expired or remaining cleaning time or to a useful life of at least one accessory.

20. High pressure cleaning system in accordance with claim 1, wherein the high pressure cleaning system has a storage unit in which cleaning profiles are saved, which have cleaning recommendations associated with objects to be cleaned, said cleaning recommendations having a linking of accessories to a value of at least one operating parameter.

21. (canceled)

22. High pressure cleaning system in accordance with claim 1, wherein at least one of the following is provided as an accessory:
a discharge unit with a flat jet nozzle;
a discharge unit with a rotor nozzle;
a discharge unit with a low pressure cleaning agent nozzle;
a discharge device comprising two or more discharge units, wherein the cleaning recommendation comprises the use of a particular one of the discharge units;
a surface cleaning device;
a washing brush;
a container for a cleaning chemical.

23. (canceled)

24. (canceled)

25. High pressure cleaning system in accordance with claim 1, wherein the input unit, the output unit, and the control unit form an integrated unit with a common housing or common support or are comprised by such an integrated unit.

26. High pressure cleaning system in accordance with claim 1, wherein the input unit, the output unit, the control unit or the integrated unit is or is comprised by a portable external accessory device to the high pressure cleaning appliance.

27. (canceled)

28. High pressure cleaning system in accordance with claim 26, wherein a user application program is provided that is stored on and is executable on the external accessory device for interaction by the user with the high pressure cleaning system.

29. (canceled)

30. (canceled)

31. (canceled)

32. (canceled)

33. (canceled)

34. High pressure cleaning system in accordance with any claim 1, wherein at least one of the following applies:
at least one control unit is arranged in or comprised by the high pressure cleaning appliances;
the high pressure cleaning system comprises at least one data processing device, which is arranged spatially remote from the high-pressure cleaning appliance and comprises at least one control unit.

35. (canceled)

36. (canceled)

37. High pressure cleaning system in accordance with claim 1, wherein the at least one operating parameter is or comprises one of the following:
a pressure of the cleaning liquid;
a pressure level of the pump assembly;
a volumetric flow of the cleaning liquid;
a volume level for cleaning liquid;
an admixing ratio of a cleaning chemical to the cleaning liquid;
a working distance of the accessory from the object to be cleaned;
use of at least one particular nozzle of the accessory for discharge the cleaning liquid;
a use of an operating mode with temporarily increased pressure (Boost) for the cleaning liquid.

38. High pressure cleaning system in accordance with claim 1, wherein the value of at least one operating parameter is specifiable to the high pressure cleaning appliance by the user by way of at least one of the input unit and/or by way of an operating unit of the high pressure cleaning appliance.

39. (canceled)

40. (canceled)

41. (canceled)

42. (canceled)

43. High pressure cleaning system in accordance with claim 1, wherein the high pressure cleaning system comprises or forms a detection unit for detecting the object and wherein information from the detection unit relating thereto is transmittable to the at least one control unit and the at least one control unit is configured to determine at least one of the object and a quality of the object on the basis of the information,
wherein the detection unit comprises a camera for creating at least one image of the object and image information relating thereto is transmittable to the at least one control unit, and wherein the control unit is configured to determine the object on the basis of the image information.

44. (canceled)

45. (canceled)

46. (canceled)

47. (canceled)

48. High pressure cleaning system in accordance with claim 1, wherein the high pressure cleaning system comprises a storage unit and wherein a user profile of the user is storable in the storage unit and wherein information linked to the user profile can be considered by the at least one control unit for the creation of the cleaning recommendation.

49. High pressure cleaning system in accordance with claim 48, wherein an interface for the user for interacting with the user profile is providable by way of the input unit and the output unit using a user application program of an accessory device, which comprises the input unit and the output unit.

50. High pressure cleaning system in accordance with claim 48, wherein at least one individualized object to be cleaned is storable, linked to the user profile, in the storage unit, said object being specifiable to the at least one control unit by the user, and wherein the cleaning recommendation is providable for the individualized object.

51. High pressure cleaning system in accordance with claim 48, wherein at least one of the following applies:
at least one accessory is linked to the user profile and information relating thereto is storable in the storage unit and wherein the cleaning recommendation is providable to the user only on the basis of the saved at least one accessory;
at least one accessory is linked to the user profile and information relating thereto is storable in the storage unit and wherein the cleaning recommendation is providable to the user independently of the at least one accessory;
a type of high pressure cleaning appliance is storable, linked to the user profile, in the storage unit and wherein the cleaning recommendation is providable in dependence on the type of high pressure cleaning appliance.

52. (canceled)

53. (canceled)

54. (canceled)

55. (canceled)

56. (canceled)

57. High pressure cleaning system in accordance with claim 1, wherein the value of at least one operating parameter is limitable by the high pressure cleaning appliance, in dependence on the accessory contained in the cleaning recommendation.

58. High pressure cleaning system in accordance with claim 1, wherein it is determinable by a control unit of the high pressure cleaning appliance during the use thereof which value of at least one operating parameter is used and/or which accessory is used, and wherein the value of at least one operating parameter is limitable by the high pressure cleaning appliance, in dependence on the accessory used.

59. High pressure cleaning system in accordance with claim 1, wherein it is determinable by the control unit of the high pressure cleaning appliance whether at least one of the value of at least one operating parameter and the accessory used deviates from the cleaning recommendation, and wherein in this case at least one of the following is performable:
providing an indication to the user, on the high pressure cleaning appliance, on an operating unit of the high pressure cleaning appliance or on the output unit;
deactivating the high pressure cleaning appliance or the pump assembly;
changing the value of the at least one operating parameter on the high pressure cleaning appliance by setting the value of the operating parameter in accordance with the cleaning recommendation;
reducing the value of the at least one operating parameter on the high pressure cleaning appliance, provided the value of the operating parameter exceeds the value in accordance with the cleaning recommendation;
transmitting information relating to the deviation to a storage unit and storing the information in the storage unit.

60. (canceled)

61. (canceled)

62. Method for operating a high pressure cleaning system comprising a high pressure cleaning appliance that has a pump assembly, at least one accessory that is in or is bringable into flow connection with a high pressure outlet of the pump assembly, wherein the high pressure cleaning appliance is operable with at least one variable operating parameter, wherein a user specifies an object to be cleaned to a control unit by way of an input unit and the control unit provides a cleaning recommendation on an output unit in dependence on the specification, comprising an instruction for using at least one of an accessory and a value of at least one operating parameter, wherein at least one interaction element is provided for the user, linked to the cleaning recommendation, on the output unit for transmitting interaction information to the at least one control unit in dependence on the cleaning recommendation.
